(19) United States
(12) Patent Application Publication
(10) Pub. No.: US 2019/0322223 A1
(43) Pub. Date: Oct. 24, 2019

(54) ACCESSORY MOUNTING BLOCK

(71) Applicants: Jeffrey D. Hancock, Uintah, UT (US); Christopher N. Schenck, Uintah, UT (US)

(72) Inventors: Jeffrey D. Hancock, Uintah, UT (US); Christopher N. Schenck, Uintah, UT (US)

(21) Appl. No.: 15/960,334

(22) Filed: Apr. 23, 2018

(51) Int. Cl. B60R 11/04; F16B 2/08

(52) U.S. Cl. CPC B60R 11/04; B60R 2011/0059; F16B 2/08

(57) ABSTRACT

A mounting block may be used to attach an accessory to a structure such as a vehicle. The mounting block may include a body with a first face on a first side of the body and a second face on a second side of the body. An opening may be disposed in the body and a first end of the opening may be disposed in the first face of the body and a second end of the opening may be disposed in the second face. The body may include a mounting surface that may be sized and configured to contact or abut a portion of the structure, such as a vehicle member. The mounting block may also include a fastener such as a worm-drive clamp. The worm-drive clamp may include an adjustment mechanism that is at least substantially disposed within the opening in the body.

### BACKGROUND

### Field of the Invention

The following embodiments are generally directed towards a mounting block and, in particular, to a mounting block that may be used to mount an accessory to a structure such as a vehicle.

### Description

Accessories may be attached to a vehicle by a bracket. For example, a bracket may be used to allow a camera, rangefinder, or light to be attached to a vehicle. Conventional brackets may be attached to a vehicle by screws, rivets, and other types of known fasteners. Conventional mounting brackets often include multiple parts and components, and are frequently custom made for a particular use or environment.

The subject matter disclosed and claimed in the present disclosure is not limited to embodiments that solve any disadvantages or that operate only in particular environments. Rather, this background is provided to illustrate one example technology area where some embodiments described herein may be practiced.

### SUMMARY

A need therefore exists for an accessory mounting block which eliminates the above-described disadvantages and problems.

One aspect is a mounting block that includes one or more elements. In some embodiments, the mounting block may include a body. The body may include one or more faces, such as a first face on a first side of the body and a second face on a second side of the body. An opening may be disposed in the body and, if desired, a first end of the opening may be disposed in the first face of the body and a second end of the opening may be disposed in the second face of the body. The body may also include a mounting surface, and the mounting surface may be sized and configured to contact, engage, or be disposed at least proximate to a surface, such as a portion of a structure such as a vehicle. A connector may be used to attach the mounting block or the body to the vehicle or structure. For example, in some embodiments, the connector may be a clamp, such as a worm-drive clamp. The worm-drive clamp, in an exemplary embodiment, may include an adjustable band and the band may include one or more thread patterns. Additionally, the worm-drive clamp may include an adjustment mechanism and the adjustment mechanism may allow the band to be tightened or loosened. For instance, the adjustment mechanism may tighten the adjustable band, which may allow the mounting block to be securely connected to a vehicle or structure. In an exemplary embodiment, the adjustment mechanism may be at least substantially disposed within the opening in the body of the mounting block.

Another aspect is a mounting block that may include a body and a connector. The body may include a first face on a first side of the body and a second face on a second side of the body. In some embodiments, an opening may be disposed in the body and the opening may extend through the body. For example, a first end of the opening may be disposed in the first face of the body and a second end of the opening may be disposed in the second face of the body. Also, the body may include a mounting surface. A connector or fastener may be at least partially disposed within the opening in the body. For example, the connector may be a worm-drive clamp and an adjustment mechanism of the worm-drive clamp may be at least partially disposed within the opening in the body. The adjustment mechanism of the worm-drive clamp may also be at least substantially disposed within the opening in the body. For instance, at least substantially disposed within the opening in the body may mean at least about seventy percent (70%), at least about eighty percent (80%), or at least about ninety percent (90%) of a length of the adjustment mechanism of the worm-drive clamp is disposed within the opening in the body. The adjustment mechanism of the worm-drive clamp may also be at least substantially entirely disposed within the opening in the body, such as at least about ninety-five percent (95%) of a length of the adjustment mechanism of the worm-drive clamp may be disposed within the opening in the body. The adjustment mechanism of the worm-drive clamp may also be entirely or completely disposed within the opening in the body.

Advantageously, if the adjustment mechanism of the worm-drive clamp is at least substantially, substantially entirely, or completely disposed within the opening in the body of the mounting block, the adjustment mechanism may be protected from damage. In addition, the adjustment mechanism may be protected from inadvertent contact, which may help prevent the adjustment mechanism from being unintentionally adjusted. The size and/or profile of the mounting block may also be decreased if the adjustment mechanism is at least partially disposed within the opening in the body of the mounting block. Additionally, the adjustment mechanism may contact or engage an inner surface of the opening, which may help secure the mounting block to a vehicle or structure. Further, if the adjustment mechanism contacts or engages an inner surface of the opening, then that contact or engagement may help prevent the mounting block and/or worm-drive clamp from unintentionally moving.

These and other aspects, features and advantages of the present invention will become more fully apparent from the following brief description of the drawings, the drawings, the detailed description of exemplary embodiments and appended claims.

### BRIEF DESCRIPTION OF THE DRAWINGS

The appended drawings contain figures of exemplary embodiments to further illustrate and clarify the above and other aspects, advantages and features of the present disclosure. It will be appreciated that these drawings depict only exemplary embodiments and are not intended to limit its scope. The drawings may illustrate various shapes, sizes, scales, relationships and configurations of the exemplary embodiments. The drawings, however, are not intended to limit the scope of the claimed invention and other shapes, sizes, scales, relationships and configurations may be appropriate. The invention will be described and explained with additional specificity and detail through the use of the accompanying drawings in which:

FIG. 1 illustrates a perspective view of an example mounting block;

FIG. 2 illustrates an enlarged perspective view of a portion of the mounting block shown in FIG. 1, illustrating an exemplary body;

FIG. 3 illustrates a side view of the mounting block shown in FIG. 1;

FIG. 4 illustrates a perspective view of the body shown in FIG. 2;

FIG. 5 illustrates a partially cutaway side view of the mounting block shown in FIG. 1;

FIG. 6 illustrates a top view of the mounting block shown in FIG. 1;

FIG. 7 illustrates an exploded view of the mounting block shown in FIG. 1;

FIG. 8 illustrates a perspective view of the mounting block shown in FIG. 1, showing the mounting block coupled to an example accessory;

FIG. 9 illustrates a perspective view of the mounting block shown in FIG. 1, showing the mounting block coupled to another example accessory;

FIG. 10 illustrates a perspective view of the mounting block shown in FIG. 1, showing the mounting block coupled to still another example accessory;

FIG. 11 illustrates a perspective view of another example mounting block;

FIG. 12 illustrates a perspective view of the mounting block shown in FIG. 11, showing the mounting block coupled to an example accessory;

FIG. 13 illustrates a perspective view of another example mounting block;

FIG. 14 illustrates a perspective view of the mounting block shown in FIG. 13, showing the mounting block coupled to an example accessory;

FIG. 15 illustrates a perspective view of another example mounting block; and

FIG. 16 illustrates a perspective view of the mounting block shown in FIG. 15, showing the mounting block coupled to an example accessory.

### DETAILED DESCRIPTION OF SOME EXEMPLARY EMBODIMENTS

The present disclosure is directed towards a mounting block that may be used to attach one or more accessories to a structure such as a vehicle. The present disclosure, however, is not limited to a mounting block that may be used to attach one or more accessories to a structure such as a vehicle. It will be understood that, in light of the present disclosure, the mounting block disclosed herein can be successfully used in connection with other types of structures and these structures may be movable or immovable.

Additionally, to assist in the description of the mounting block, words such as top, bottom, front, rear, right and left are used to describe the accompanying figures. It will be appreciated, however, that the mounting block can be located in a variety of desired positions, including various angles, sideways and even upside down. Further, the drawings may show the mounting block, along with various components, attachments, and accessories, to scale. The drawings, however, are not necessarily to scale and the mounting block, components, attachments, and/or accessories may have other suitable shapes, sizes, configurations, and arrangements. A detailed description of the mounting block now follows.

Advantageously, the mounting block may allow one or more accessories to be attached to a structure such as a vehicle. After reviewing this disclosure, one skilled in the art may appreciate that a manner in which a mounting block is attached and/or attaches an accessory to a vehicle may affect one or more aspects such as functionality, versatility, aesthetics, convenience, safety, etc. After reviewing this disclosure, one skilled in the art may also appreciate that the mounting block may have an effect on the vehicle, on the accessory, a user that rides in/on the vehicle, and/or a user that uses the accessory. Some example factors or example scenarios in which the mounting block may have an effect include transporting the vehicle, driving the vehicle, forces or loads applied to the vehicle and/or accessory, vehicle impacts and/or crashes, installing the mounting block, or attaching one or more accessories. Other example factors or example scenarios in which the mounting block may have an effect may include after-market parts of a vehicle, capability of attaching the mounting block to different types, sizes, and configurations of vehicles, attaching a variety of different accessories to the vehicle, etc. Other suitable factors or suitable scenarios in which the mounting block may be advantageously implemented are within the scope of the present disclosure. One of ordinary skill in the art will appreciate, in light of the present disclosure, the mounting block, the accessory, the vehicle, and other related features disclosed herein can be successfully used in connection with a wide variety of applications.

In accordance with one or more embodiments, the mounting block may include a body and a connector. The connector may secure the mounting block to a vehicle or a portion of a vehicle. For example, the connector may be a clamp and a portion of the vehicle may be disposed within the clamp. In greater detail, the body of the mounting block may include a mounting surface and the mounting surface may be disposed adjacent to or abut a portion of the vehicle. The connector may be adjustable to allow the mounting block to be securely connected or attached to a portion of the vehicle, such as a vehicle member. For instance, tightening of the connector may cause the mounting surface of the mounting block and a portion of the vehicle, such as the vehicle member, to contact or abut. Tightening of the connector may also cause a portion of the connector to contact or abut a portion of the vehicle, such as the vehicle member. If desired, an interior portion of the connector and the mounting surface of the body of the mounting block may contact or engage a portion of the vehicle, such as the vehicle member.

In some embodiments, at least a portion of the connector may be positioned or at least partially disposed inside the mounting block. For example, at least a portion of the connector may be disposed within an opening within the body of the mounting block. It will be appreciated that the mounting block may include one or more openings and/or one or more connectors. For example, a first connector may be disposed in a first opening in the body of the mounting block. If desired, a second connector may be disposed in a second opening in the body of the mounting block. Advantageously, by at least partially disposing the connector inside the mounting block via one or more openings, the connector may be partially protected (e.g., from branches, boat docks, water/mud splashes, etc.). Additionally or alternatively, at least partially disposing the connector inside the one or more openings in the body of the mounting block may be a safety feature. For instance, if an adjustment mechanism of the connector is at least partially, at least substantially, substantially entirely, or completely disposed within the opening in the body of the mounting block, the adjustment mechanism of the connector may be protected and/or may prevent harm (e.g., inflicting scrapes, lacerations, etc. due to contact during entry/exit into/from the vehicle, loading/unloading the vehicle, driving the vehicle, reaching for or grabbing an accessory, accidents, crashes, etc.). Additionally or alternatively, disposing the adjustment mechanism within an opening may help prevent unintentional adjustment of the connector. Additionally or alternatively, disposing the adjustment mechanism of the connector inside an opening may cause the body and the connector to move together. For example, an impact on an accessory attached to the mounting block may cause the accessory and the mounting block to move simultaneously.

The mounting block may allow one or more accessories to be attached to a structure such as a vehicle. If desired, the mounting block may be used in connection with various types of accessories and the mounting block may include a universal type connector to facilitate use with different accessories. For example, an accessory coupling structure may be used to couple an accessory to the mounting block. An exemplary accessory coupling structure that may be used in connection with the mounting block is disclosed in U.S. Pat. No. 9,079,539, issued Jul. 14, 2015, which is incorporated by reference in its entirety.

In the present disclosure, reference to “vehicle” may refer to any device or machine that is movable from a first geographic position (e.g., “Point A”) to a second geographic position (e.g., “Point B”). In these or other embodiments, the vehicle may be human-driven, semi-autonomous, or autonomous. Examples of vehicles may include all-terrain vehicles (ATVs), utility task vehicles (UTVs or side-by-sides), dirt bikes, motorcycles, golf carts, watercraft (e.g., boats, personal watercraft, etc.), automobiles, pickups, semi-trucks, robots, drones, equipment (e.g., construction/maintenance equipment such as backhoes, excavators, bulldozers, loaders, etc.), or any other suitable devices. The vehicle may or may not be required to carry a load (e.g., a human rider/driver, a delivery package, a payload, etc.).

In the present disclosure, reference to “vehicle member” may include a portion or element of the vehicle. Examples of vehicle members may include roll cages, grills, frame members, tubing, handles, guards (e.g., grill guards), racks, plates, covers, bumpers, hitches, joints, arms, awnings, stiffeners, supports, tow towers, etc. The vehicle member may have a variety of different shapes, sizes, configurations, and/or arrangements. For example, the vehicle members may have perimeters, cross-sections, and the like that are round, oval, oblong, curved, square, polygon, and the like. Thus, for example, the vehicle member may include one or more surfaces that are straight and/or curved.

In the present disclosure, reference to “accessory” may include and/or relate to any part or component that may be added, attached, or connected to a vehicle; may replace a part, portion, or product of a vehicle; may be related to a function or design of the vehicle; may be related to safety; may be related to an environment of the vehicle; and/or may be related to wants/needs of a user. Examples of accessories may include video recording equipment (e.g., camera, GoPro®, camcorder, mobile device, etc.), safety equipment (e.g., fire extinguisher, medical kit, emergency kit, flag, etc.), lighting equipment (e.g., light bar, spotlight, signal light, emergency light, aesthetic light, accent light, etc.), navigation equipment (e.g., GPS device, golf course play-tracking device, etc.), sound equipment (e.g., portable speaker, BlueTooth® speaker, megaphone, etc.), carrying/transportation equipment (e.g., gun hold/rack/case, bow hold/rack/case, pack hold, gear hold, meat hold, ski/wakeboard rack, cargo hold, etc.), hunting equipment (e.g., rangefinder, binoculars, spotting scope, ammunition case, shooting sticks, etc.), and the like, including any mounts to receive, support, or hold the foregoing.

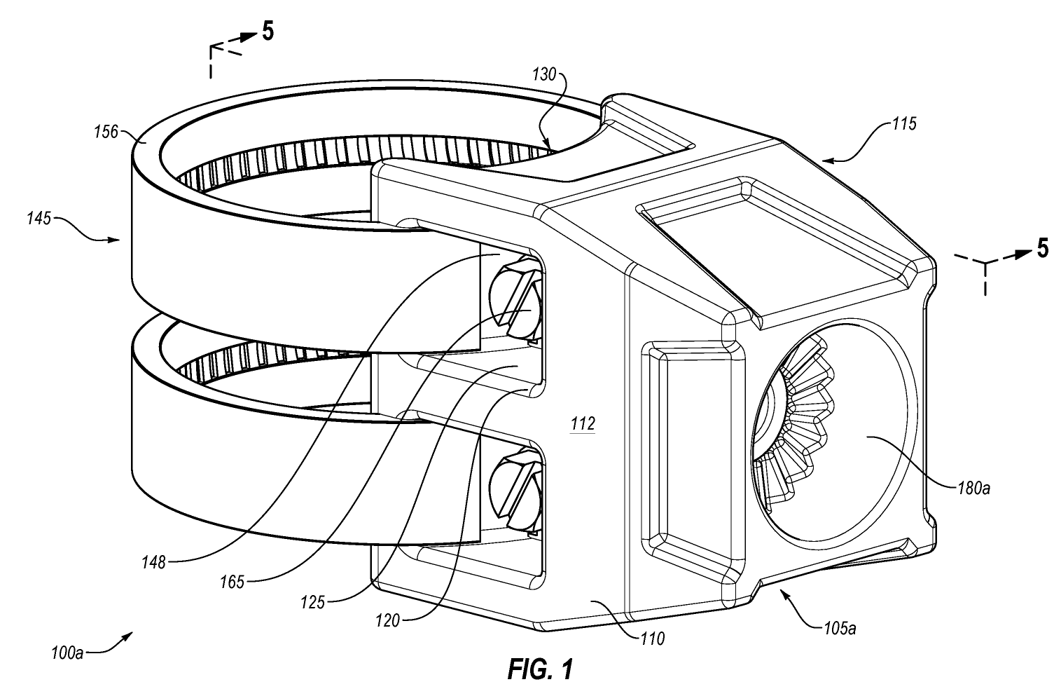

Turning to the figures, FIG. 1 illustrates a perspective view of an example mounting block 100a, arranged according to one or more embodiments of the present disclosure. As illustrated, the mounting block 100a of FIG. 1 may include a body 105a and a fastener 145. The body 105a may include a first face 110 on a first side 112, a second face 115 on a second side, an opening 120 with an interior surface 125, a mounting surface 130, and an accessory coupling structure 180a. The fastener 145 may include an adjustable band 148, an overmolded portion 156, and an adjustment mechanism 160 with an adjustment member 165.

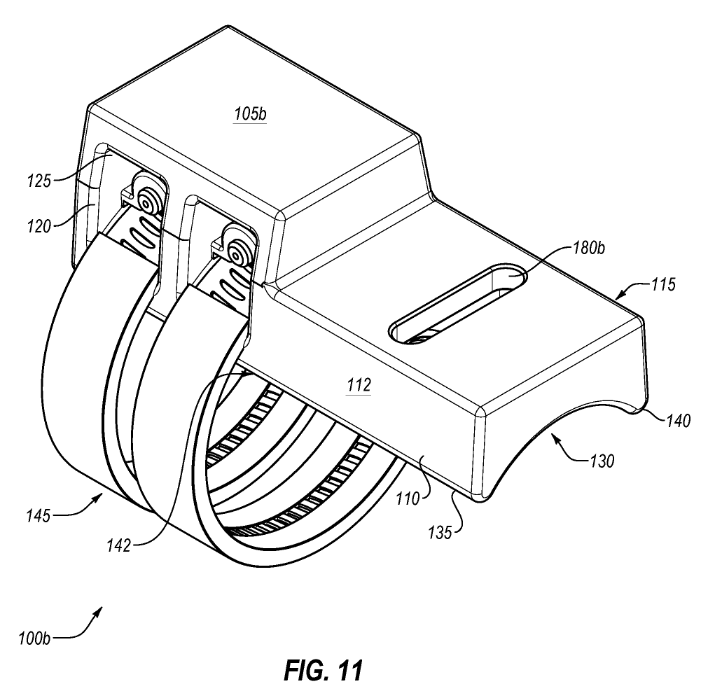

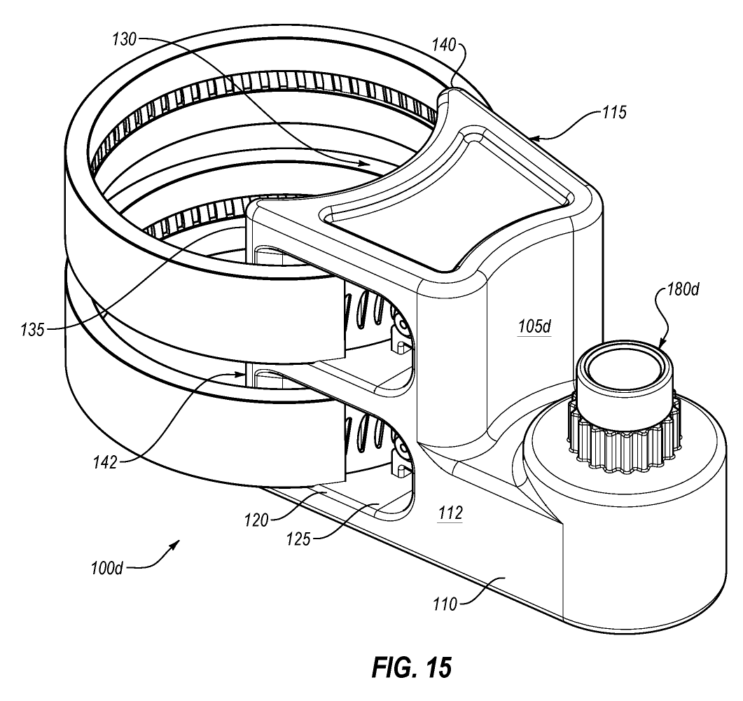

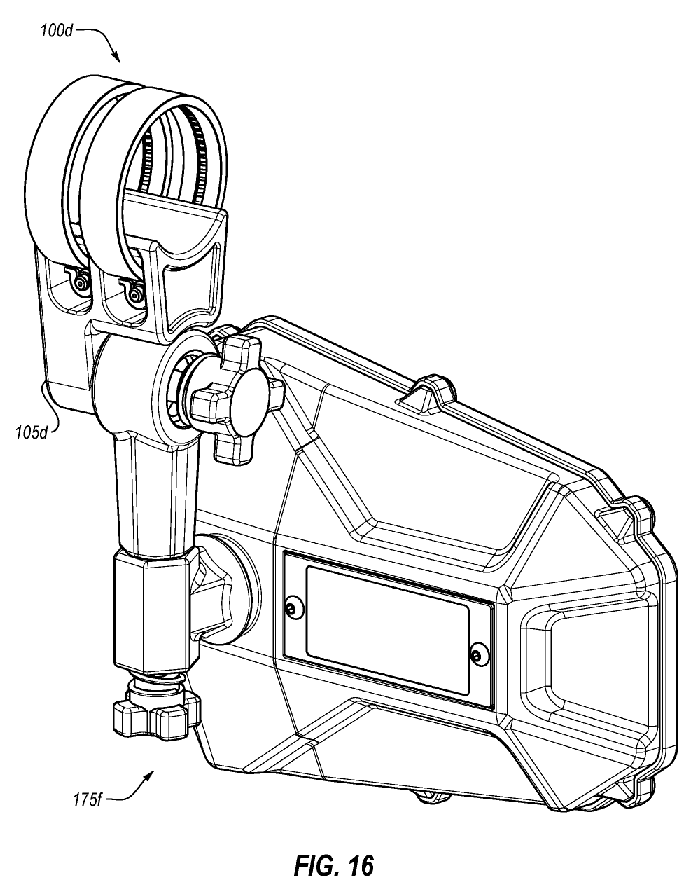

The body 105a may include a variety of shapes, sizes, load ratings, material properties, etc. according to a particular application, environment, and/or a size, shape or weight of an accessory to be coupled to the body 105a (e.g., via the accessory coupling structure 180a). For example, the body 105a may be cube-like, rectangle-like (e.g., FIGS. 11-14), “L-shaped” (e.g., FIGS. 15-16), cylindrical-shaped, or any other suitable shape, without limitation and in any combination of suitable shapes. Additionally or alternatively, the body 105a may include various tapers, cutouts, slopes, curvatures, chamfers, rounded edges, and the like. In some embodiments, the body 105a may be constructed from a plastic material, a metal material, or other suitable material. The body 105a may be manufactured or formed by molding (such as injection molding, blow-molding, extrusion molding, rotational molding, etc.), printing (such as three-dimensionally printing), casting (e.g., die casting), machining, and the like.

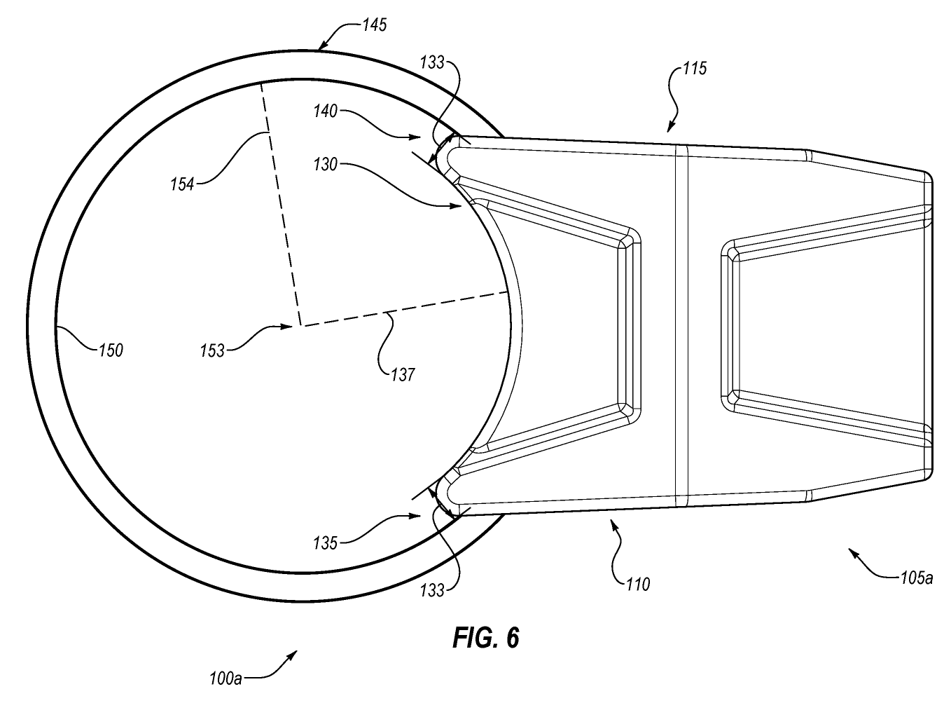

In these or other embodiments, the body 105a may include various faces and sides, for example, the first face 110 may be on the first side 112 and the second face 115 may be on the second side. If desired, the first face 110 on the first side 112 may be opposite the second face 115 on the second side. Additionally, the first face 110 and the second face 115 may be disposed approximately parallel relative to each other. Thus, in some embodiments, a distance between the first face 110 and the second face 115 may be approximately the same (as illustrated in FIG. 6).

In some embodiments, the opening 120 may be disposed in the body 105a and the opening may extend completely through the body 105a. For example, the opening 120 may include a first end in the first face 110 and a second end in the second face 115. The opening 120 may be a slot, an aperture, a thru-hole, a curved hole, a channel, and any other suitable type of opening. The opening 120 may be sized and configured to allow a portion of the fastener 145 to be disposed in the opening 120. Thus, in some embodiments, the opening 120 may be sized and shaped according to the fastener 145 such that a portion of the fastener 145 may be positioned inside the opening 120. In particular, a portion of the fastener 145 may be disposed between the first end of the opening 120 in the first face 110 and the second end of the opening 120 in the second face 115. For example, a portion of the adjustable band 148, adjustment mechanism 160, and/or the rotatable adjustment member 165 of the adjustment mechanism 160 may be disposed inside the opening 120 of the body 105a. Additionally or alternatively, other portions of the fastener 145 may be positioned within the opening 120. In these or other embodiments, the opening 120 may help provide access to the rotatable adjustment member 165, which may allow the adjustment mechanism 160 to be adjusted. In some embodiments, the rotatable adjustment member 165 may be a threaded member such as a screw, a bolt, etc. For example, as illustrated in FIG. 1, the rotatable adjustment member 165 may be a hex screw that may be rotated or turned via a flat head screw driver and the like.

In some embodiments, the adjustment mechanism 160 may be at least substantially disposed within the opening 120, while in other embodiments, fully disposed within the opening 120. Additionally or alternatively, the rotatable adjustment member 165 may be at least substantially disposed within the opening 120, while in other embodiments, fully disposed within the opening 120. Substantially disposed within the opening 120 may refer to an amount of surface area for a respective part that does not break respective planes defined by the first face 110 and/or the second face 115 (e.g., how much surface area of the part is inside the opening 120 and not protruding past one or both of the first face 110 and the second face 115). For example, a part substantially disposed within the opening 120 may include about 75% to about 80% of a surface area of the part disposed in the opening 120, about 80% to about 85% of the surface area of the part disposed in the opening 120, and about 85% to about 99% of the surface area of the part disposed in the opening 120. Additionally or alternatively, substantially disposed within the opening 120 may refer to a length of a respective part that does not break the respective planes defined by the first face 110 and/or the second face 115 (e.g., what length of the part is inside the opening 120 and not protruding past one or both of the first face 110 and the second face 115). The length of a part may be measured according to any arbitrarily defined axis or orientation. For example, a part substantially disposed within the opening 120 may include about 75% to about 80% of a length of the part disposed in the opening 120, about 80% to about 85% of the length of the part disposed in the opening 120, and about 85% to about 99% of the length of the part disposed in the opening 120.

In some embodiments, by positioning one or more portions of the fastener 145 inside the opening 120 in the mounting block 100a, at least a portion of the fastener 145, such as the adjustment mechanism 160, may be protected (e.g., from branches, boat docks, water/mud splashes, etc.). Additionally or alternatively, if a portion of the fastener 145, such as the adjustment member 160, is at least partially disposed in the opening 120 of the mounting block 100a, this may be a safety feature such that various portions of the fastener 145 do not inflict harm (e.g., inflict scrapes, lacerations, etc. due to unintentional striking during entry/exit into/from the vehicle, loading/unloading the vehicle, driving the vehicle, reaching for or removing/replacing the accessory, accidents, crashes, etc.). For example, sharp edges of the adjustment mechanism 160 and/or ends of the adjustable band 148 may be disposed within the opening 120. Additionally or alternatively, the opening 120 of the mounting block 100a may help to inhibit unintentional adjustment of the fastener 145 by positioning of the adjustment mechanism 160 inside the opening 120. Additionally or alternatively, if a portion of the fastener 145 is positioned inside the opening 120 of the mounting block 100a, such as the adjustment mechanism 160, then that positioning may enable the body 105a and the fastener 145 to slide or move together. For example, if impact occurs to the mounting block 100a and/or the accessory, then the accessory, the body 105a and the fastener 145 may simultaneously move together. This may help mitigate or eliminate injuries and/or damage to the mounting block 100a and/or any accessories or attachments.

In some embodiments, portions of the fastener 145 may cooperate with and/or engage the interior surface 125 of the opening 120. For example, as the rotatable adjustment member 165 is turned (e.g., turned clockwise), the adjustable band 148 may adjust and decrease a perimeter of the fastener 145. Additionally or alternatively, as the rotatable adjustment member 165 is turned (e.g., turned counter-clockwise), the adjustable band 148 may adjust and increase the perimeter of the fastener 145. Thus, the adjustable band 148 may contact or engage the interior surface 125 of the opening 120. In this manner, portions of the fastener 145 may cooperate with and/or engage the interior surface 125 of the opening 120.

The adjustment mechanism 160 of the fastener 145 may also cooperate with and/or engage the interior surface 125 of the opening 120. For example, a side of the adjustment mechanism 160 may contact, abut, or engage the side of the opening 120. Thus, as the rotatable adjustment member 165 is turned, the adjustment member 160 may contact, abut, or engage the interior surface 125, such as a sidewall, of the opening 120. Advantageously, contact of the adjustment mechanism 160 with an interior surface 125 of the opening 120 may help facilitate secure engagement of the fastener 145 and the body 105a of the mounting block 100a.

Contact forces between the adjustable band 148 of the faster 145 and/or the mounting surface 130 of the body 105a may allow secure attachment of the mounting block 100a to a structure or a vehicle, such as a vehicle member. As referred to herein, “contact force” may include frictional force, tension force, compression force, normal force, applied force, spring force, etc. For example, when a vehicle member is positioned inside the fastener 145 and the adjustable band 148 is adjusted, the mounting block 100a may be secured to the vehicle member. In more detail for example, there may be a sufficient amount of contact force between the fastener 145 and the vehicle member and/or between the vehicle member and the mounting surface 130.

In these or other embodiments, the fastener 145 may include any hardware that joins, affixes, or may help to join or affix two or more objects together. Examples of fasteners may include clamps (e.g., worm-drive clamps, spring clamps, etc.), retaining rings, springs, screws, nuts, bolts, rivets, pins, press fits, snap fits, shrink fits, seams, crimps, and any other suitable type of fastener. As illustrated in the exemplary embodiment shown in FIG. 1, the fastener 145 is a worm-drive clamp. In these or other embodiments, the overmolded portion 156 of the fastener 145 may include a custom fit overmolding to the fastener 145. The overmolded portion 156 may include any pliable and/or rubber-like overlay or sleeve such as a thermoplastic elastomer (TPE). The overmolded portion 156 may be manufactured in a variety of ways, including insert molding or multiple-shot molding. The overmolded portion 156 may protect the adjustable band 148 from damage. Additionally or alternatively, the overmolded portion 156 may protect a user (e.g., from scratches, lacerations, etc.). Additionally or alternatively, the overmolded portion 156 may protect the vehicle member. Additionally or alternatively, the overmolded portion 156 may provide aesthetic appeal. For example, the overmolded portion 156 may help impart a sleek look or design.

The adjustable band 148 may be constructed from any suitable material such as metal, rubber, and/or plastic. As illustrated in the exemplary embodiment shown in FIG. 1, the adjustable band 148 is a metal band of the worm-drive clamp. In these or other embodiments, the adjustable band 148 may adjust to a size, shape, configuration and/or arrangement of the vehicle member, which may impart a universal quality to the mounting block 100a. For example, the mounting block 100a may be mounted to numerous sorts of vehicle members of vehicles of a wide variety of makes, models, part numbers, and part sizes without a custom or specific adjustable band 148. Additionally or alternatively, the adjustable band 148 may include one or more threads. In these or other embodiments, the threads may be engaged by the adjustment mechanism 160. For example, a worm gear of the adjustment mechanism 160 may engage the threads of the adjustable band 148 such that the adjustable band 148 may be adjusted. In these or other embodiments, the rotatable adjustment member 165 may be integral to the worm gear that engages the threads of the adjustable band 148.

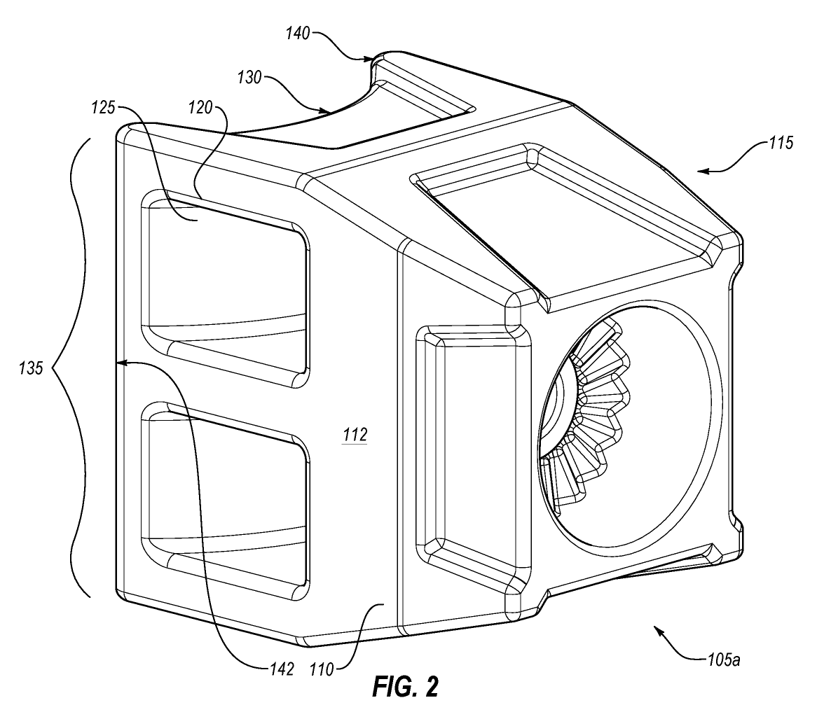

FIG. 2 is a perspective view of the body 105a arranged according to one or more embodiments of the present disclosure. As illustrated in FIG. 2, the mounting block 100a may include the body 105a, the first face 110 on the first side 112, the second face 115 on the second side, the opening 120, the interior surface 125, the mounting surface 130, a first edge 135, a second edge 140, and a central edge portion 142.

In some embodiments, the first edge 135 and the second edge 140 may define a front region of the first face 110 and the second face 115, respectively. Additionally or alternatively, the first edge 135 and the second edge 140 may define approximate edges of the mounting surface 130. For example, the mounting surface 130 may be disposed between the first edge 135 and the second edge 140 such that the mounting surface 130 may span partially or entirely between the first edge 135 and the second edge 140.

In some embodiments, the body 105a may include multiple openings 120. For example, FIG. 2 illustrates two openings 120 disposed in the body 105a. In these or other embodiments, respective first ends for a first opening 120 and a second opening 120 may be disposed within the first face 110. Additionally or alternatively, respective second ends for the first opening 120 and the second opening 120 may be disposed within the second face 115.

In some embodiments, for example in the case of multiple openings 120, the openings 120 may be positioned relative to the central edge portion 142. The central edge portion 142 may be positioned in a central area along the first edge 135 and the second edge 140. For example, the openings 120 may be positioned on opposite sides of the central edge portion 142 (e.g., as illustrated in FIG. 2). In other embodiments, the openings 120 may be positioned on a same side of the central edge portion 142 (e.g., as illustrated in FIG. 11 in another example mounting block). By positioning the openings 120 at various positions along a direction of the first edge 135 and the second edge 140 (e.g., relative to the central edge portion 142), different contact forces and/or bending moments may result. For example, an accessory may necessitate or allow a larger or smaller mounting surface 130. Positioning the one or more openings 120 at various positions relative to the central edge portion 142, the first edge 135, and/or the second edge 140 may result in more secure attachment, improved load distribution, enhanced impact resistance, better load transfer, decreased internal stresses, decreased bending moments, and the like.

In some embodiments, the interior surfaces 125 of the openings 120 may include curved surfaces, flat surfaces, or a combination of curved and flat surfaces. Additionally or alternatively, various surfaces of the interior surfaces 125 may be an engaging surface that engages the adjustable band 148 and/or the adjustment mechanism 160. Additionally or alternatively, some of the interior surfaces 125 of the openings 120 may be shaped (e.g., curved) correspondingly to a shape of the adjustable band 145, adjustment mechanism 160, and/or the mounting surface 130. For example, the portion of the interior surface 125 that engages with an interior portion of the adjustable band 148 may be shaped (e.g., curved or flat) the same, similar to, or different from the shape of the mounting surface 130. In addition, an outer portion of the adjustment mechanism 160 may be sized, shaped, configured, and/or arranged to engage a portion of the interior surface 125 of the opening 120.

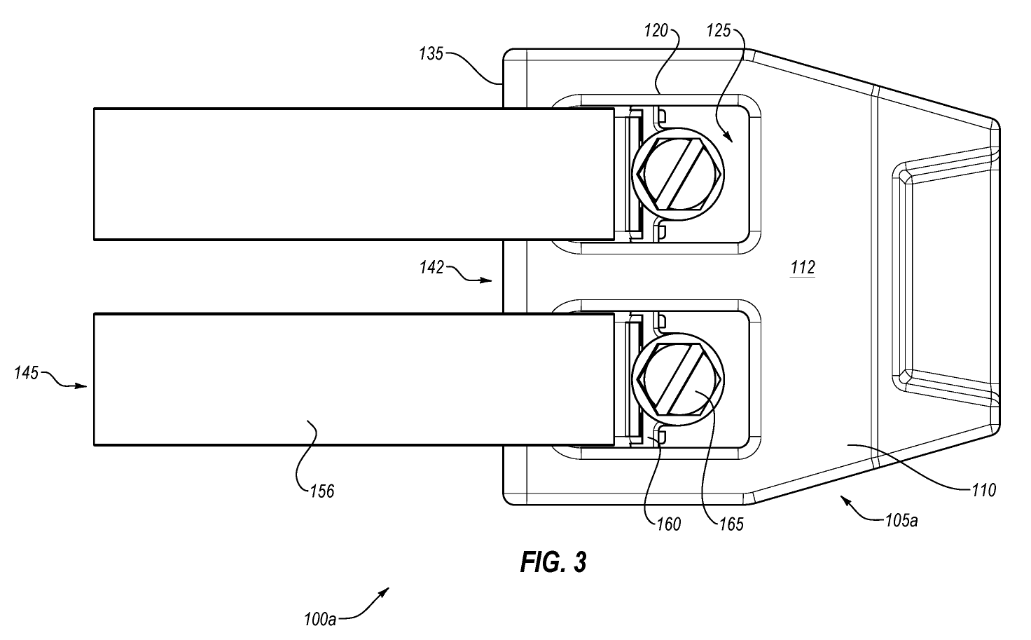

FIG. 3 is a side view of the mounting block 100a arranged according to one or more embodiments of the present disclosure. As illustrated in FIG. 3, the mounting block 100a may include the body 105a, may include the first face 110 on the first side 112, the second face 115 on the second side, the opening 120 with the interior surface 125, the mounting surface 130, the first edge 135, the central edge portion 142, the fastener 145 with the overmolded portion 156, the adjustment mechanism 160, and the rotatable adjustment member 165.

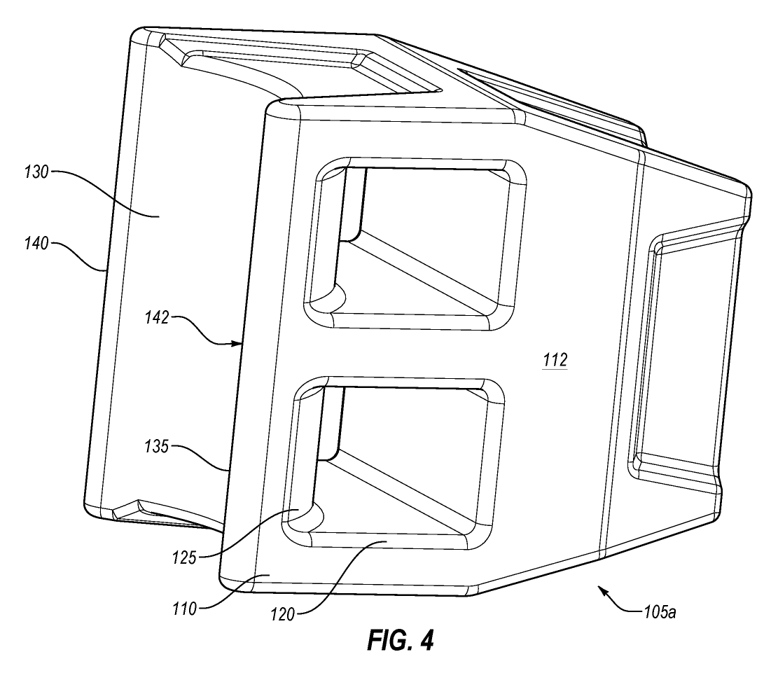

FIG. 4 is a perspective view of the body 105a arranged according to one or more embodiments of the present disclosure. As illustrated in FIG. 4, the mounting block 100a may include the body 105a, the first face 110 on the first side 112, the opening 120 with the interior surface 125, the first edge 135, the second edge 140, the central edge portion 142, and the mounting surface 130.

In some embodiments, the mounting surface 130 may be a curved surface while in other embodiments a flat surface, a combination of curved and flat surfaces, multiple curved surfaces, or multiple flat surfaces. Additionally, in some embodiments, the mounting surface 130 may be a single contiguous surface without edges, creases, or gaps while in other embodiments multiple surfaces may be separated by an edge, crease, or gap. In these or other embodiments, the mounting surface 130 may be sized and configured to be mountable to a structure or vehicle, such as a vehicle member. The vehicle member, for example, may be round, square, rectangular, or the like. The vehicle member may also have a variety of other shapes, sizes, configurations, and arrangements depending, for example, upon the type of vehicle. The mounting surface 130 may be sized and configured to provide a universal quality to the body 105a. For instance, the mounting surface 130 may be mounted to vehicle members of different shapes, sizes, configurations, and/or arrangements that may allow the mounting block 100a to be mounted to a wide variety of vehicles and vehicles of different makes, models, part numbers, and part sizes. Advantageously, a custom or specific mounting surface 130 may not have to be used with the mounting block 100a. Additionally or alternatively, the mounting surface 130 need not match or correspond to a portion of the vehicle member. The mounting surface 130, however, may match or correspond to a portion of the vehicle member. In addition, the mounting surface 130 may be customized and/or tailored to a specific size, shape, configuration and/or arrangement depending, for example, upon the intended use of the mounting block 100a.

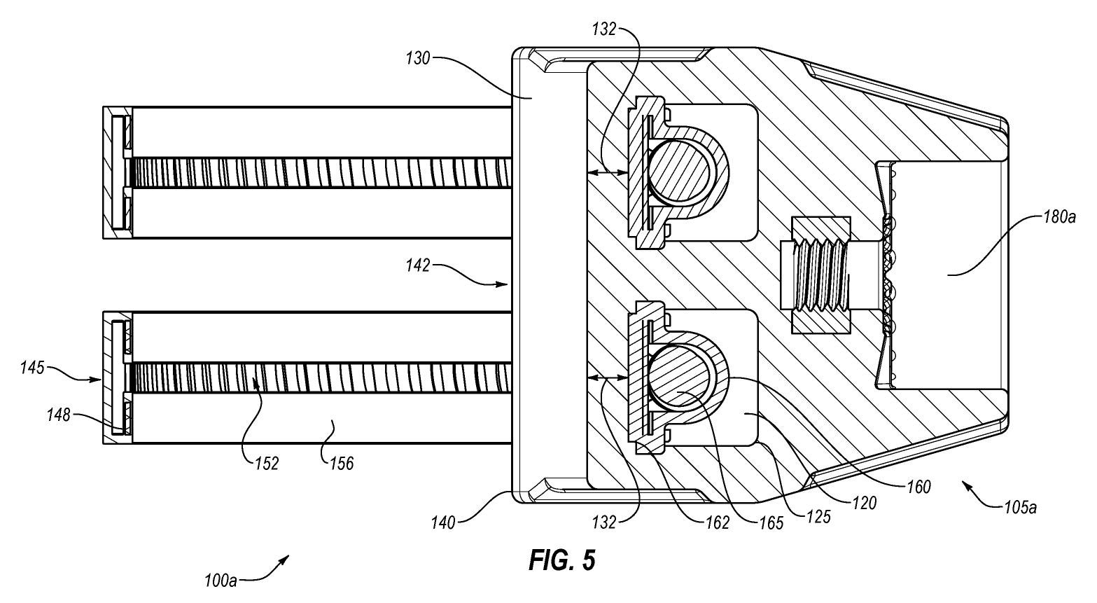

FIG. 5 is a partially cutaway side view of the mounting block 100a arranged according to one or more embodiments of the present disclosure. As illustrated, the body 105a may include the opening 120 with the interior surface 125, the mounting surface 130 having a wall thickness 132, the second edge 140, the central edge portion 142, and the accessory coupling structure 180a. The fastener 145 may include the adjustable band 148, the overmolded portion 156, a thread pattern 152, the adjustment mechanism 160, an outer surface 162 of the adjustment mechanism 160, and the rotatable adjustment member 165.

In some embodiments, the outer surface 162 of the adjustment mechanism 160 may be part of a housing. The housing may house a worm gear that engages threads of the thread pattern 152 on the adjustable band 148. For example, the housing may house the rotatable adjustment member 165 such that the rotatable adjustment member 165 may engage the threads of the thread pattern 152 as part of the worm gear in the adjustment mechanism 160.

In these or other embodiments, the outer surface 162 of the adjustment mechanism 160 may engage the interior surface 125 of the opening 120. For example, as the adjustable band 148 adjusts, the outer surface 162 of the adjustment mechanism 160 may contact, abut, or engage the interior surface 125. In this manner, portions of the fastener 145 may cooperate with and/or engage the interior surface 125 of the opening 120. In these or other embodiments, the adjustment mechanism 160, including the outer surface 162 of the housing and the rotatable adjustment member 165, may be disposed at least substantially, substantially entirely, or completely within the opening 120.

In some embodiments, there may be multiple fasteners 145, such as one fastener 145 for each opening 120. In these or other embodiments, the fasteners 145 and/or openings may be the same or similar to those described above.

In some embodiments, the accessory coupling structure 180a may include a recess, a ring of engaging teeth that engage an accessory, and/or a threaded hole to receive a corresponding threaded member such as a bolt, screw, etc. The accessory coupling structure 180a may be the same or similar to that described in the U.S. Pat. No. 9,079,539.

In some embodiments, the mounting surface 130 may include a wall thickness 132. In these or other embodiments, the wall thickness 132 may be a distance between a lower surface of the opening 120 and the mounting surface 130). The wall thickness 132 may be sufficiently thick such that the fastener 145, when securing the mounting block 100a to a vehicle member, does not cause the mounting surface 130 to plastically deform or does not otherwise induce internal stresses detrimental to a portion of the body 105a. The wall thickness 132 of the mounting surface 130 may be approximately the same between the first face 110 and the second face 115. Thus, the wall thickness 132 may be generally constant. The wall thickness 132, however, may vary depending, for example, upon the intended use of the mounting block 100a. For example, the wall thickness 132 may not be generally constant because the curvature (or lack thereof) of the lower surface of the opening 120 and the mounting surface 130 may not be the same. Additionally or alternatively, the wall thickness 132 may not be approximately the same given a curvature (or lack thereof) of the interior surface 125 between the first face 110 and the second face 115. Additionally or alternatively, the wall thickness 132 may be greater at portions where the opening 120 is not laterally adjacent to the mounting surface 130 (e.g., at the central edge portion 142, the wall thickness 132 may be greater than at some other portion).

FIG. 6 is a top view of the mounting block 100a arranged according to one or more embodiments of the present disclosure. As illustrated, the mounting block 100a may include the body 105a, the first face 110, the second face 115, the mounting surface 130, an offset 133, the first edge 135, the second edge 140, a radius of curvature 137 of the mounting surface 130, a radius of curvature 154 of the fastener 145, a center 153, and an interior portion 150 of the fastener 145.

In some embodiments, the radius of curvature 137 of the mounting surface 130 may be a radial distance from the mounting surface 130 to the center 153 (e.g., the radial center 153). In some embodiments, the radius of curvature 154 of the fastener 145 may be a radial distance from the fastener 145 to the center 153. In these or other embodiments, the radius of curvature 137 and the radius of curvature 154 may be approximately equal (e.g., exactly equal, within about 10% or within about 15% of value). For example, the radius of curvature 137 and the radius of curvature 154 may differ by an amount equal to the offset 133. In such cases, the radius of curvature 154 minus the radius of curvature 137 may be approximately equal to the offset 133.

In other embodiments, the radius of curvature 137 and the radius of curvature 154 may not be approximately equal. In some examples, the radius of curvature 154 may be larger (e.g., much larger) than the offset 133 plus the radius of curvature 137. For example, a vehicle member mounted to the mounting surface 130 may be relatively large such that radius of curvature 154 is not within about 10% or within about 15% of the radius of curvature 137.

Additionally or alternatively, the radius of curvature 154 may be smaller than the radius of curvature 137. For example, a vehicle member may be sufficiently small such that the fastener 145 when securely tightened against the vehicle member may result in the radius of curvature 154 being less than the radius of curvature 137.

Additionally or alternatively, there may be multiple radiuses (or radii) of curvature 154. For example, a vehicle member may include one or more edges, one or more different surfaces, and/or a non-circular or atypical cross-section. In such cases, when the fastener 145 is securely tightened against the vehicle member, one radius of curvature 154 may be different from another radius of curvature 154. In these or other embodiments, portions of the fastener 145 may be straight (e.g., without any radius of curvature 154 or “zero” radius of curvature).

In some embodiments, the offset 133 may be approximately equal to the wall thickness 132 of the mounting surface 130. For example, the greater the wall thickness 132, the greater the offset 133 may be. In such a case, the fastener 145 may enter into the opening 120 of the body 105a at a greater distance away from the mounting surface 130. Additionally or alternatively, the thinner the wall thickness 132 is, the smaller the offset 133 may be. In such a case, the fastener 145 may enter into the opening 120 of the body 105a at a lesser distance away from the mounting surface 130.

In some embodiments, the interior portion 150 of the fastener 145 may include an inner perimeter of the fastener 145. For example, the interior portion 150 may be an interior portion of the adjustable band 148, while in other cases the interior portion 150 may be an interior portion of the overmolded portion 156. Various portions and/or elements may be disposed within the interior portion 150. For example, the mounting surface 130, the first edge 135, the second edge 140, the interior surface 125 of the opening 120, the center 153, etc. may be positioned inside the interior portion 150 of the fastener 145. In these or other embodiments, various portions of the interior portion 150 may be an engaging surface. For example, portions of the interior portion 150 may engage a vehicle member and/or the interior surface 125 of the opening 120. As described above, “engage” may include contacting, abutting, touching, and the like. For instance, in response to securing a vehicle member to the mounting surface 130, an interior portion of the overmolded portion 156 may engage the vehicle member by a compression force. Additionally or alternatively, for instance, in response to securing the vehicle member to the mounting surface 130, an interior portion of the adjustable band 148 may engage the interior surface 125. After reviewing this disclosure, one skilled in the art will appreciate that other suitable engaging actions may be employed.

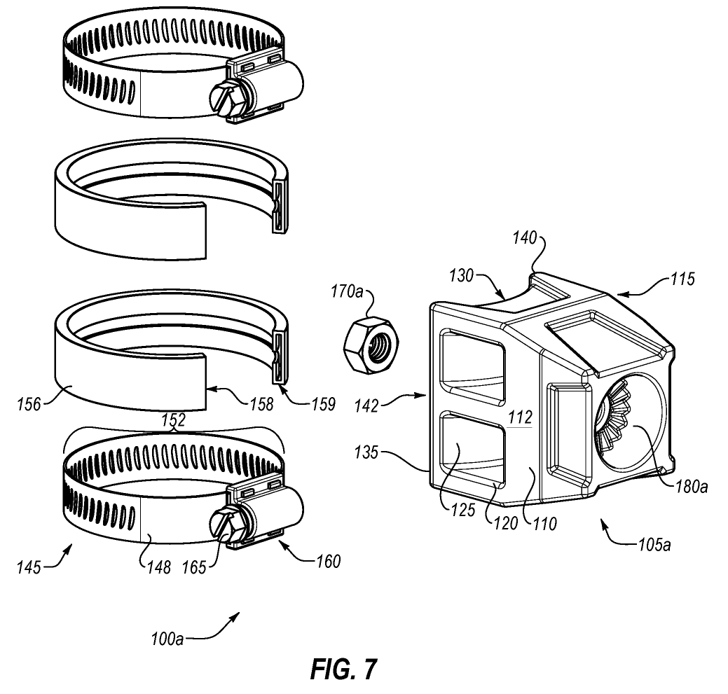

FIG. 7 is an exploded view of the mounting block 100a arranged according to one or more embodiments of the present disclosure. As illustrated, the mounting block 100a may include the body 105a, which may include the first face 110 on the first side 112, the second face 115 on the second side, the opening 120 with the interior surface 125, the mounting surface 130, the first edge 135, the second edge 140, the central edge portion 142, and a nut 170a. The mounting block 100a may also include the fastener 145, which may include the adjustable band 148, the adjustment mechanism 160, the rotatable adjustment member 165, the thread pattern 152, and the overmolded portion 156 having a first end 158 and a second end 159.

In some embodiments, the first end 158 of the overmolded portion 156 may be disposed in the first end of the opening 120 in the first face 110 of the body 105a. Additionally or alternatively, the second end 159 of the overmolded portion 156 may be disposed in the second end of the opening 120 in the second face 115 of the body 105a. Thus, in some embodiments, the first end 158 and the second end 159 of the overmolded portion 156 may be positioned on respective sides of the adjustment mechanism 160. In greater detail, the first end 158 and the second end 159 of the overmolded portion 156 may (when fitted over the adjustable band 148) be positioned proximate to the adjustment mechanism 160. Additionally or alternatively, when the adjustment mechanism 160 of the fastener 145 is positioned within the opening 120, the first end 158 and the second end 159 may also be positioned within the opening 120.

As shown in FIG. 7, the mounting block 100a may include a nut 170a. The nut 170a may help to couple an accessory to the accessory coupling structure 180a. For example, the accessory may include a screw or bolt which is coupled to the accessory coupling structure 180a and/or the nut 170a.

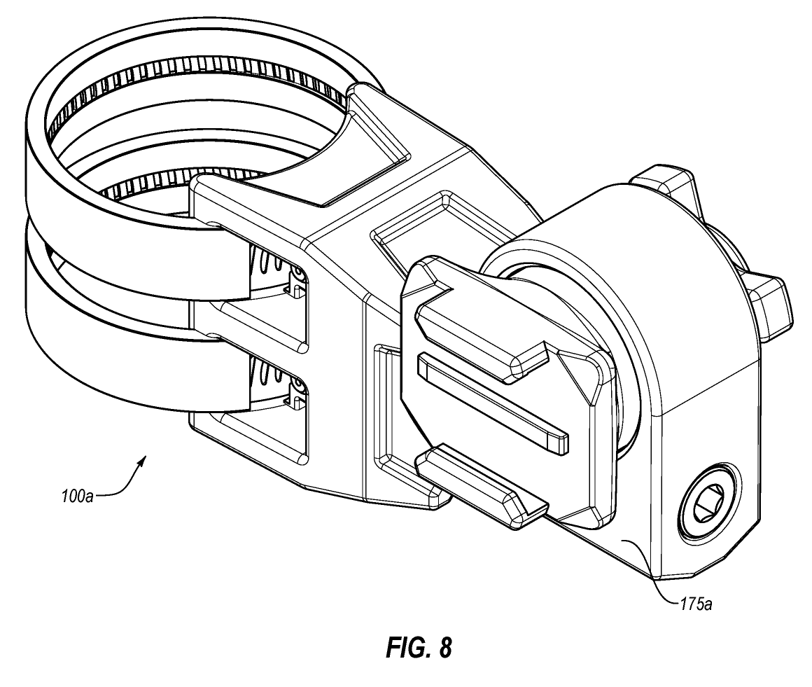

FIG. 8 is a perspective view of the mounting block 100a coupled to an example accessory 175a arranged according to one or more embodiments of the present disclosure. As illustrated, the accessory 175a may be configured to receive a GoPro®, an optics device, an imaging device, a video recording device, a camcorder, a rangefinder, and/or other suitable accessory. For example, the accessory 175a may include various locking features (e.g., locking knobs, mechanical stops, etc.), slide features, guide features, rotation/swivel features, vibration damping features, etc. It will be appreciated that the accessory 175a may provide other desired aspects, features, functionality, and/or purposes depending, for example, upon the intended use of the structure, the vehicle, and/or the mounting block 100a.

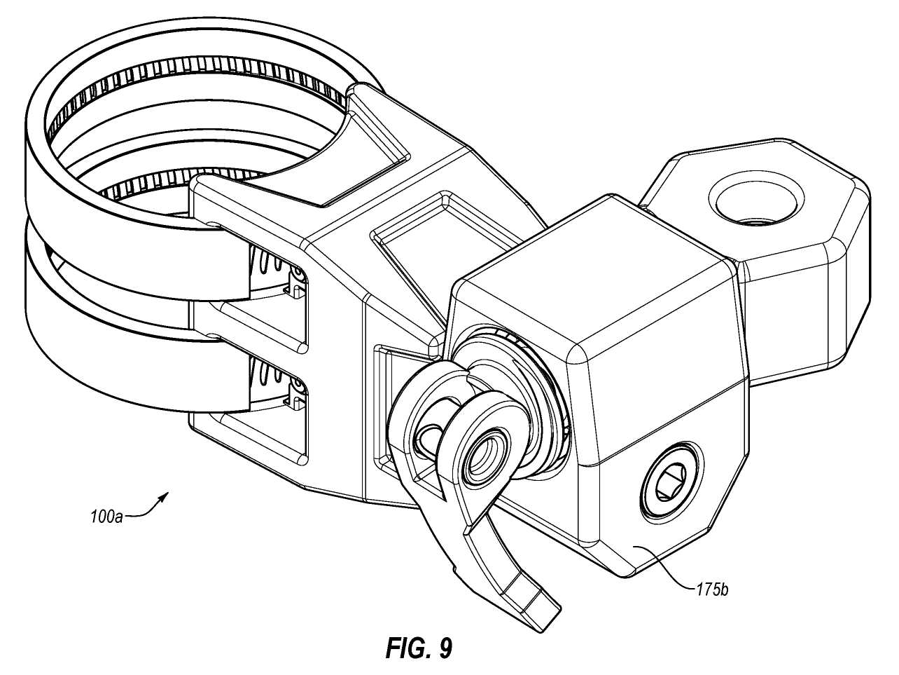

FIG. 9 is a perspective view of the mounting block 100a coupled to another example accessory 175b arranged according to one or more embodiments of the present disclosure. As illustrated, the accessory 175b may be configured to receive a flag, such as a whip flag, a safety flag, a nation flag, a sports team flag, and the like. The accessory 175b may also be shaped, sized, configured, and/or arranged to receive or be connected to another suitable accessory such as an antenna, aerial, mast, and the like. In addition, the accessory 175b may include various locking features (e.g., a cam-compression latch), recesses, rotation/swivel features, vibration damping features, etc. It will be appreciated that the accessory 175b may provide other desired aspects, features, functionality, and/or purposes depending, for example, upon the intended use of the structure, the vehicle, and/or the mounting block 100a.

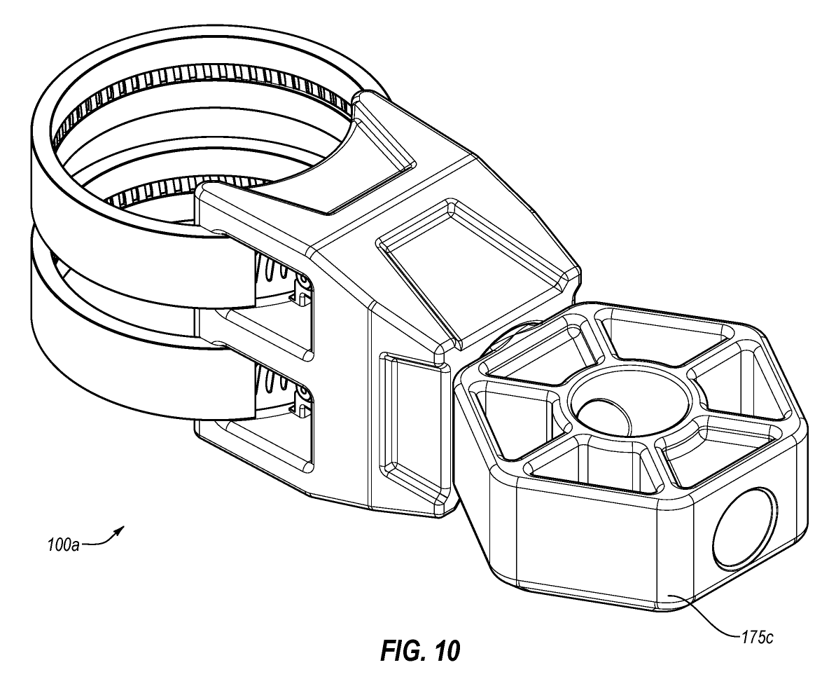

FIG. 10 is a perspective view of the mounting block 100a coupled to another example accessory 175c arranged according to one or more embodiments of the present disclosure. The accessory 175c may be sized, shaped, configured, and/or attached to provide light such as a lighting element, a spotlight, a signal light, an emergency light, an aesthetic light, an accent light, or other suitable accessory. It will be appreciated that the accessory 175c may provide other desired aspects, features, functionality, and/or purposes depending, for example, upon the intended use of the structure, the vehicle, and/or the mounting block 100a.

FIG. 11 is a perspective view of another example mounting block 100b arranged according to one or more embodiments of the present disclosure. As illustrated, the mounting block 100b may include a fastener, such as the fastener 145 discussed above, and a body 105b, which may have a different size, shape, configuration, and/or arrangement than the body 105a discussed above. One or more aspects of the body 105b may be similar to the body 105a (for ease of reference and readability, the same reference numbers may be used in connection with the body 105a and 105b). For example, the body 105b may include a first face 110 on a first side 112 of the body 105b, a second face 115 on a second side of the body 105b, an opening 120 with an interior surface 125, a first edge 135 and a second edge 140, a mounting surface 130, a central edge portion 142, and an accessory coupling structure 180b. Thus, portions of the body 105b may be the same or similar to the body 105a described above. For example, various elements of the body 105b may have different size proportions or positions compared to the body 105a.

For instance, the first edge 135 and the second edge 140 of the body 105b shown in FIG. 11 may be longer than the first edge 135 and the second edge 140 of the body 105a shown in FIGS. 1-10. Additionally or alternatively, the mounting surface 130 of the body 105b shown in FIG. 11 may be larger (e.g., longer/wider) than the mounting surface 130 of the body 105a shown in FIGS. 1-10. The additional surface area of the mounting surface 130 may allow larger accessories to be coupled to a vehicle member because, for example, a load of the accessory may be effectively transferred to the vehicle member. Additionally or alternatively, the openings 120 may be positioned on a same side as the central edge portion 142 in contrast to the openings 120 shown in FIGS. 1-10.

In some embodiments, the accessory coupling structure 180b may include an opening, such as a thru-hole, in the mounting surface 130. The thru-hole may help to allow custom positioning of an accessory by slidably positioning a bolt and the corresponding accessory along any point of the thru-hole. Additionally or alternatively, the accessory coupling structure 180b may include a recess formed into the mounting surface 130 that corresponds to the thru-hole. For example, a nut or other suitable fastener may secure the bolt and corresponding accessory to the body 105b. The nut or other suitable fastener may be disposed within the recess such that the nut or other suitable fastener does not break a surface plane defined by the mounting surface 130.

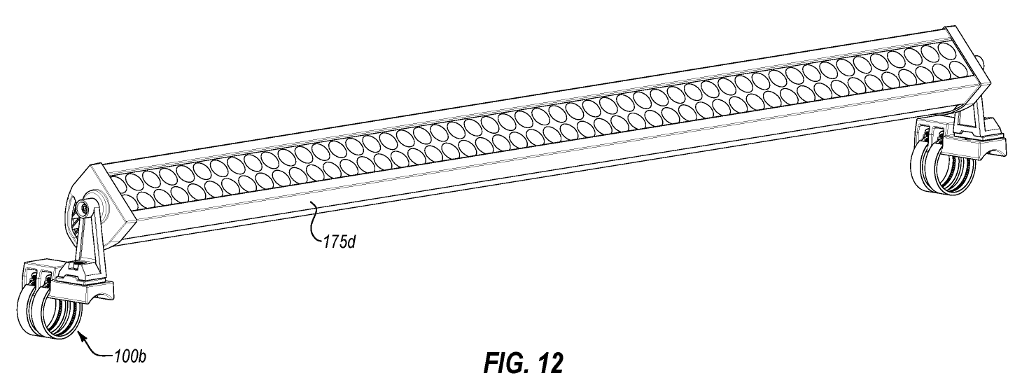

FIG. 12 is a perspective view of the mounting block 100b coupled to an example accessory 175d arranged according to one or more embodiments of the present disclosure. As illustrated, the accessory 175d may be a lighting element such as light bar, a spotlight, a signal light, an emergency light, an aesthetic light, an accent light, or any other suitable accessory.

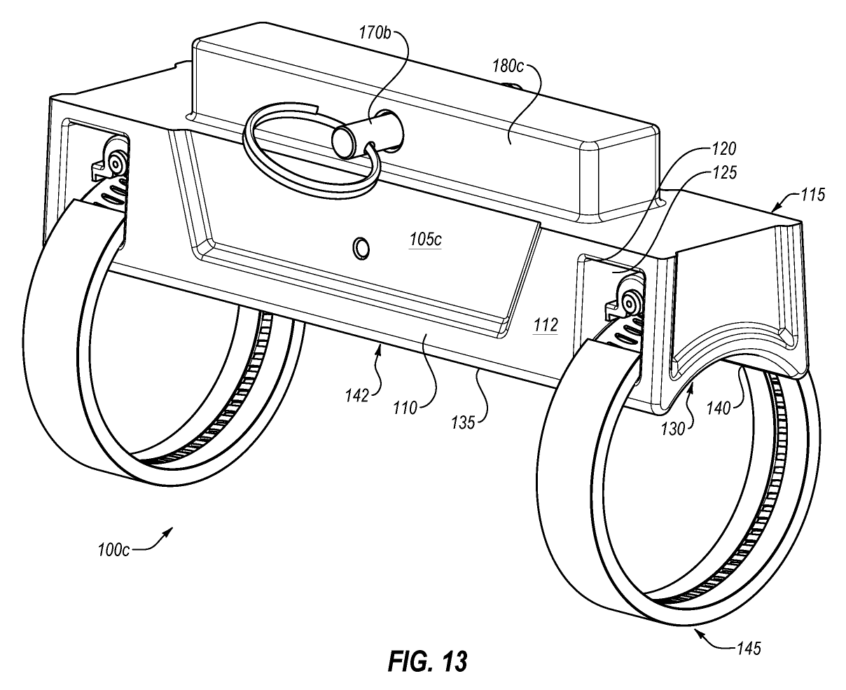

FIG. 13 is a perspective view of another example mounting block 100c arranged according to one or more embodiments of the present disclosure. As illustrated in FIG. 13, the mounting block 100c may include a fastener, such as the fastener 145 discussed above, and a body 105c. One or more aspects of the body 105c may be similar to the body 105a and/or the body 105c (for ease of reference and readability, the same reference numbers may be used in connection with the body 105a, 105b, and/or 105c). The body 105c may include a first face 110 on a first side 112, a second face 115 on a second side, an opening 120 with an interior surface 125, a mounting surface 130, a first edge 135 and a second edge 140, a lock pin 170b, and an accessory coupling structure 180c. The body 105c may be the same as or similar to the body 105a and the body 105b described above.

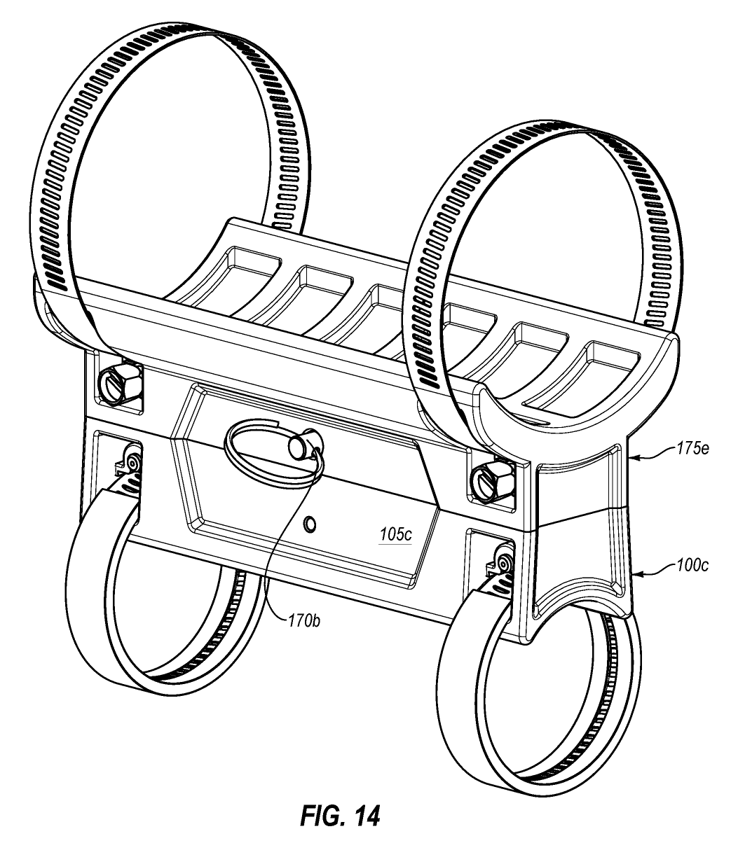

In some embodiments, the accessory coupling structure 180c and may include a thru-hole disposed within an engaging portion. The engaging portion of the accessory coupling structure 180c may be received by a corresponding receiving portion within an accessory. The receiving portion may include a thru-hole that corresponds to the thru-hole disposed within the engaging portion of the body 105c. After the mounting block 100c is coupled to the accessory via the connection (e.g., as illustrated in FIG. 14), the thru-hole of the engaging portion of the accessory coupling structure 180c may align with the thru-hole of the accessory (e.g., the accessory 175e) such that the lock pin 170b may be inserted into the aligned thru-holes.

FIG. 14 is a perspective view of the mounting block 100c coupled to an example accessory 175e arranged according to one or more embodiments of the present disclosure. The accessory 175e may be used to detachably connect a device, a part, a component, or the like to a structure such as a vehicle member. For example, the accessory 175e may be used to detachably connect safety equipment to a vehicle member. For example, the accessory 175e may allow safety equipment, such as a fire extinguisher, medical kit, emergency kit, etc., to be attached to a vehicle member.

FIG. 15 is a perspective view of another example mounting block 100d arranged according to one or more embodiments of the present disclosure. As illustrated in FIG. 15, the mounting block 100d may include a fastener, such as the fastener 145 discussed above, and a body 105d. One or more aspects of the body 105d may be similar to the body 105a (for ease of reference and readability, the same reference numbers may be used in connection with the body 105a and 105d). For example, the body 105d may include a first face 110 on a first side 112, a second face 115 on a second side, an opening 120 with an interior surface 125, a mounting surface 130, a first edge 135, a second edge 140, and an accessory coupling structure 180d. All or a portion of the body 105d may be the same as or similar to the body 105a, the body 105b, and/or the body 105c described above.

In some embodiments, the accessory coupling structure 180d may include an engaging portion with one or more teeth (e.g., a ring of teeth). The accessory coupling structure 180d may be configured to couple with an accessory (e.g., the accessory 175f shown in FIG. 16) that includes a receiving portion with corresponding teeth features to engage the accessory coupling structure 180d. In these or other embodiments, the accessory coupling structure 180d may be disposed in any suitable direction such that the accessory may be oriented or disposed in a suitable fashion or position.

FIG. 16 is a perspective view of the mounting block 100d shown in FIG. 15 coupled to an example accessory 175f arranged according to one or more embodiments of the present disclosure. As illustrated, the accessory 175f may include a mirror (e.g., a rear-view mirror, a side mirror, a reverse camera, etc.) or other suitable accessory that may be adjusted and/or configured to be disposed in a desired position. Advantageously, the accessory 175f may be used to provide additional vehicle safety such as increased vehicle awareness, reduced blind spots, etc.

After reviewing this disclosure, one skilled in the art will appreciate the mounting block 100 may have various shapes, sizes, configurations, and/or arrangements. Additionally, while the accompanying drawings illustrate various exemplary embodiments of the mounting block 100, the mounting block 100 may include other parts, components, and the like. In addition, the various features illustrated in the drawings may be drawn to scale, but not necessarily. Further, the drawings may be simplified for clarity and the drawings may not depict all of the features, components, or the like.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. Unless otherwise described herein with respect to a particular element of the present disclosure, the terms “about,” “approximately,” and “substantially” may be interpreted as within 15% of actual value(s), target value(s), possible value(s), and predicted value(s).

In addition, even if a specific number of an introduced claim recitation is explicitly recited, such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used in the present disclosure to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A mounting block comprising:
a body comprising:
a first face on a first side of the body;
a second face on a second side of the body;
an opening disposed in the body, a first end of the opening disposed in the first face of the body and a second end of the opening disposed in the second face of the body; and
a mounting surface; and
a worm-drive clamp comprising:
an adjustable band with a thread pattern; and
an adjustment mechanism that adjusts the adjustable band, the adjustment mechanism at least substantially disposed within the opening in the body.

2. The mounting block of claim 1, wherein an outer portion of the adjustment mechanism engages an interior surface of the opening.

3. The mounting block of claim 1, wherein the adjustment mechanism is at least partially disposed within a housing; and
wherein the housing is at least substantially disposed within the opening in the body.

4. The mounting block of claim 1, wherein the adjustment mechanism is completely disposed within the opening.

5. The mounting block of claim 1, wherein the mounting surface is disposed within an interior portion of the worm-drive clamp; and
wherein a radius of curvature of the mounting surface is approximately equal to a radius of curvature of the worm-drive clamp disposed within the opening in the body.

6. The mounting block of claim 1, wherein a radius of curvature of the mounting surface is approximate to a radius of curvature of the adjustable band disposed within the opening in the body.

7. The mounting block of claim 1, wherein a portion of the adjustable band of the worm-drive clamp includes an engaging surface that engages an interior surface of the opening; and
wherein a portion of the adjustment mechanism of the worm-drive clamp includes an engaging surface that engages an interior surface of the opening.

8. The mounting block of claim 1, further comprising a rotatable adjustment member of the adjustment mechanism, the rotatable adjustment member at least substantially disposed within the opening.

9. The mounting block of claim 8, wherein the opening provides access to the rotatable adjustment member to allow the adjustment mechanism to be adjusted.

10. The mounting block of claim 1, wherein the adjustable band of the adjustment mechanism includes an overmolded portion, a first end of the overmolded portion is disposed in the first end of the opening and a second end of the overmolded portion is disposed in the second end of the opening.

11. The mounting block of claim 1, wherein the opening disposed in the body is a first opening and further comprising a second opening in the body, a first end of the second opening disposed in the first face of the body and a second end of the second opening disposed in the second face of the body.

12. The mounting block of claim 11, wherein the worm-drive clamp is a first worm-drive clamp, the adjustment mechanism of the first worm-drive clamp at least substantially disposed within the first opening of the body; and
further comprising a second worm-drive clamp, the second worm-drive clamp comprising:
a second adjustable band with a second thread pattern; and
a second adjustment mechanism that adjusts the second adjustable band of the second worm-drive clamp, the second adjustment mechanism at least substantially disposed within the second opening in the body.

13. A mounting block comprising:
a body comprising:
a first face on a first side of the body;
a second face on a second side of the body;
an opening disposed in the body, a first end of the opening disposed in the first face of the body and a second end of the opening disposed in the second face; and
a mounting surface; and
a fastener at least partially disposed within the opening in the body, the fastener including an adjustment mechanism that adjusts the fastener, the adjustment mechanism at least substantially disposed within the opening in the body.

14. The mounting block of claim 13, wherein the adjustment mechanism of the fastener is completely disposed within the opening in the body.

15. The mounting block of claim 13, wherein a portion of the adjustment mechanism engages an interior surface of the opening.

16. The mounting block of claim 13, wherein an outer surface of the adjustment mechanism engages an interior surface of the opening; and
wherein an interior portion of an adjustable band of the fastener engages an interior surface of the opening.

17. The mounting block of claim 13, wherein a radius of curvature of the mounting surface is approximate to a radius of curvature of the fastener disposed within the opening in the body.

18. The mounting block of claim 13, wherein the fastener includes a rotatable adjustment member to adjust the adjustment mechanism;
wherein the rotatable adjustment member is at least substantially disposed within the opening; and
wherein the opening provides access to the rotatable adjustment member to allow the adjustment mechanism to be adjusted.

19. The mounting block of claim 13, wherein the fastener includes adjustable band with an overmolded portion, a first end of the overmolded portion is disposed in the first end of the opening and a second end of the overmolded portion is disposed in the second end of the opening.

20. The mounting block of claim 13, wherein the opening disposed in the body is a first opening and the body includes a second opening in the body;
wherein the fastener is a first fastener;
wherein the adjustment mechanism is a first adjustment mechanism of the first fastener at least substantially disposed within the first opening in the body; and
wherein a second fastener is at least partially disposed within the second opening in the body, the second fastener including a second adjustment mechanism at least substantially disposed within the second opening of the body.
